(19) United States
(12) Patent Application Publication
(10) Pub. No.: US 2002/0052048 A1
(43) Pub. Date: May 2, 2002

(54) Method for multi-fluorescence detection

(75) Inventors: Karsten Stein, Berlin (DE); Lutz Pfeifer, Berlin (DE); Andre Lehmann, Berlin (DE)

Correspondence Address: BRUCE LONDA, NORRIS, MCLAUGHLIN & MARCUS, P.A., 220 EAST 42ND STREET, 30TH FLOOR, NEW YORK, NY, 10017, US

(73) Assignee: IOM Innovative optische Messtechnik GmbH, Berlin (DE)

(21) Appl. No.: 10/002,514

(22) Filed: Oct. 25, 2001

(30) Foreign Application Priority Data
Oct. 27, 2000 (DE) 100 54 426.6

(51) Int. Cl. G01N 21/76

(52) U.S. Cl. 436/172

(57) ABSTRACT

The invention concerns a method for the multiple fluorescence detection of fluorophores.

The task assignment of the invention, to develop a category-related method with which the described disadvantages of the state of the art are avoided and with which an ultrasensitive and quick detection of multiple fluorescences of fluorophores in the range of sub-nanoseconds to a few milliseconds is simultaneously ensured, is solved by a simultaneous measurement of the decay time of the fluorescences, where the excitation wave lengths for the individual fluorophores, delayed through an optical delay 4 in the range of sub-nanoseconds to some milliseconds, are conducted to the objects of examination so that the fluorescences can be excitated and detected one after the other.

For the differentiation between at least two fluorophores in addition to their spectral characteristics, the decay behaviour of the fluorescence processes is examined by the displacement of electronic gates in the nanosecond range along a timing axis.

### DESCRIPTION

The invention concerns a method for the multi-fluorescent detection in accordance with the claims 1, 2 and 3.

The term “fluorescent colouring material” is understood to mean a molecule species occurring naturally in the object of examination as well as a fluorescent molecule species added for the purposes of marking, for example by means of chemical binding. Furthermore, fluorescent colouring material is also understood to mean protein fluorescences induced by gene transfer, such as for example “green fluorescent protein” (GFP), “blue fluorescent protein” (BFP) and their derivatives.

Fluorescence spectroscopic measuring methods are gaining growing significance as a result of the high level of verification sensitivity and specificness, particularly in the fields of biotechnology and medical diagnostics.

The characterisation of properties of cells and tissue plays a major role in the recognition and localisation of pathologically changed tissue, in the quality control of transplantation material or in the process control in cell cultivation.

Cells have the feature of sending out a characteristic fluorescence following radiation with a shot-wave light. For this behaviour, particularly cell-inherent molecules participating in the metabolic activity are responsible, such as nicotinamide adenine dinucleotide (NADH), flavine, porphyrine.

In order to excitate fluorescence, the fluorophores are radiated with monochromatic light in the absorption maximum. Either filtered lamps or lasers are used as excitation sources. The required fluorescence band is selected by means of spectral filtering of the emission.

In addition to this, laser-induced fluorescence signals can be generally evaluated for the characterisation of an object to be examined, such as solutions or surfaces of solid bodies.

The usual methods for fluorescence detection are static methods which provide information on the intensity and the spectral distribution of the emitting light, in most cases in the form of a static fluorescence spectrum. No statements can be made as a rule on the timing decay behaviour of the fluorescences.

When samples with several different fluorescence markings are presented, the individual fluorophores are verified timingly or spatially one after the other. For this purpose, a sophisticated filter change facility (with laser excitation, several lasers) is necessary not only for the fluorescence excitation but also for the fluorescence emission.

Examples in this case are given by the fluorometers available from BMG Labtechnologies GmbH, D-77656 Offenburg, BIO-TEK Kontron Instruments GmbH, D-85375 Neufahrn, Packard Instrument Company, Connecticut/USA, Wallac Distribution GmbH, D-79111 Freiburg.

The disadvantageous factor with these known equipment items is that a simultaneous measurement of the various fluorescence molecule species is not possible, but instead only a timingly successive measurement of the samples. These measurements are also unsatisfactorily time-consuming to a high degree, a fact which is partly due to the required filter change (filter wheels).

Several fluorophores cannot be simultaneously verified with the previously known methods when high sensitivity is demanded; it is not possible to detect local- and time-changing samples. If all fluorophores were excitated and detected at the same time during multiple marking, then the verification limits would increase to such a considerable degree as a result of emission superimpositions, light scattering and excitation overlay in the detection channel that no satisfactory statements can be obtained for most analytical questions.

A four-channel fluorescence detector for the application in the capillary electrophoresis (U.S. Pat. No. 6,039,925) attempts to bypass the problem involving the filter change by positioning four microlenses arranged in a row with four band fitting filters located longitudinally at a capillary. The sample moves along the capillary longitudinally, going past the four detection points.

The disadvantage with this arrangement is the fact that, with continuous light excitation, a feedover of the excitation beam of one channel onto another detection channel cannot be avoided. This feedover caused by light scattering processes in the solution, in glasses and at boundary lines can never be thoroughly avoided. The selectivity of the simultaneous verification of the four various fluorophores must therefore remain considerably restricted.

Multiple fluorescences cannot be significantly separately detected with stationary simultaneous measurements.

The task assignment of the invention is to develop a category-related method with which the described disadvantages of the state of the art are avoided and with which an ultrasensitive and quick detection of multiple fluorescences of fluorophores in the range of sub-nanoseconds to a few milliseconds is simultaneously ensured.

The task assignment of the invention is solved by methods according to the features of the claims 1, 2 and 3.

According to the features of claim 1 the excitation wave lengths for the individual fluorophores, delayed through an optical delay in the range of sub-nanoseconds to some milliseconds, are conducted to the objects of examination and, for the purpose of differentiation between at least two fluorophores and in addition to their spectral characteristics, the decay behaviour of the fluorescence processes is examined along a timing axis by the displacement of electronic gates in the range of sub-nanoseconds to some milliseconds.

With the combination of the principle of the delayed fluorescence excitation with the principle of the gated signal scanning, a maximum significance in the separation of multiple fluorescences is achieved.

According to the features of claim 2 the excitation wave lengths for the individual fluorophores, delayed through an optical delay in the range of sub-nanoseconds to some milliseconds, are conducted to the objects of examination so that the fluorescences can be excitated and detected one after the other.

With the process for multi-fluorescence detection of fluorophores by means of simultaneous measurement of the decay time of the fluorescences according to claim 3, and for the differentiation between a minimum of two fluorophores in addition to their spectral characteristics, the decay behaviour of the fluorescence processes is examined by the displacement of electronic gates in the nanosecond range along a timing axis. An increased significance of the fluorescence separation can be used only in this case when the adopted fluorophores indicate significant differences of the fluorescence life duration.

With the method according to the invention, and by means of the additionally gained time information, substances can be differentiated whose spectral properties are similar.

In addition to high sensitivity, a maximum of selectivity can be obtained during signal detection by means of a different positioning of an electronic time gate.

With the use of the method for the detection of several, different fluorescence-marked dissolved samples in the liquid chromatography, the verification of all fluorescence markings at the same time and at the same location is possible, in which case peak changes in the chromatogram can be avoided.

A selective detection is ensured of the samples, not spatially separated by the chromatography, by means of their fluorescence properties.

With the use of the method for the detection of several, different fluorescent samples in all electrophoretic separating methods, the verification of all fluorescences is possible in real time at the same location, in which case the band and/or the peak changes in the electrophoretogram can be avoided.

A selective detection is ensured of the samples, not spatially separated by the electrophoresis, by means of their fluorescence properties.

With the use of the method for the detection of fluorescence colouring materials in multi well plates, the detection of all fluorescence colouring materials is more or less possible at the same time (in real time) within only one scan operation without the time-consuming switchover of filters.

All sample fluorescences can be detected while avoiding a temperature action in the way it can occur during sequential measuring methods.

The kinetics of several, differently marked samples can be detected simultaneously.

With the use of the method for the polymerase chain reaction (PCR) and, in this case, particularly for the quantitative and the multiplex-PCR, several amplified fluorescence colouring materials can be quantitatively detected, simultaneously and in real time, during one amplification process and therefore an end point determination, as a termination condition for a successful process, can be carried out.

With the use of the method for the multiple fluorescence detection on living tissue, the quantitative or semi-quantitative detection of sample fluorescences or their relationships is possible by means of avoiding stochastic or repetitive movements of the tissues as a result of heart beat, lung movement or other causes. The influence of an adequately slow change of the geometric arrangement of excitation and detection optics on the relationship measurement of the different fluorescent samples is avoided.

With the use of the method for the multiple fluorescence detection on planer, particular, fibrillar carriers such as DNA-/protein-chip, the samples can be scanned without stopping the mechanical system because the movement has no influence on the relationships of the fluorescence signals.

The methods according to the invention open the way to a large application spectrum for areas in which conventional fluorescence spectrometers fail, such as for example in examinations of samples in dissolved form, differentiation of tissue conditions, metabolic examinations, growth phases of biotechnological cell cultures in bioreactors, analytical separating processes such as CZE, HPLC.

Purposeful embodiments of the invention are described in the subclaims.

The invention will be better understood on the basis of a concrete embodiment example as described below in greater detail. The relevant drawing shows the following:

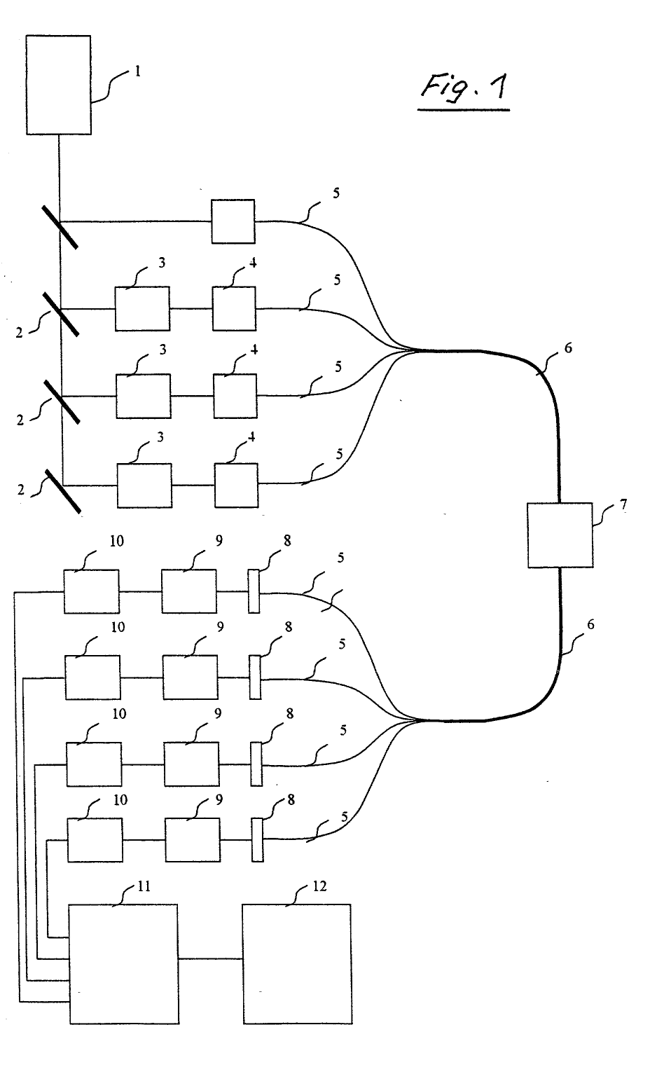

FIG. 1: the schematic illustration of a concrete embodiment example for four different fluorescence markers and

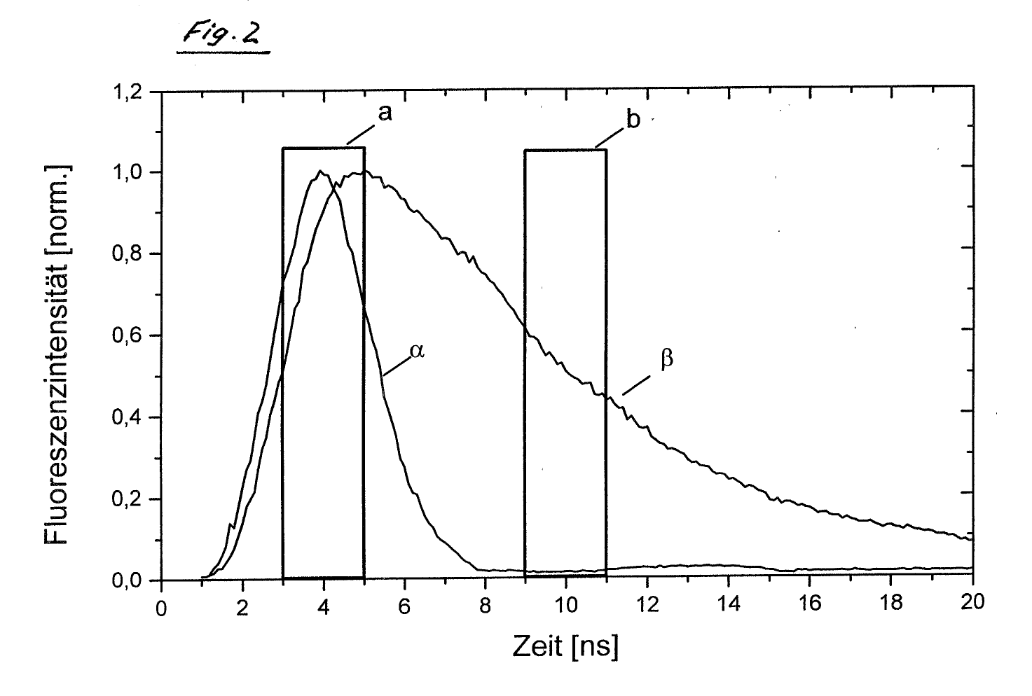

FIG. 2: the graphic illustration of the behaviour of fluorescence signals of two colouring materials over the time.

In accordance with the illustration in FIG. 1, an impulse laser 1 is used as an excitation source, e.g. a nitrogen laser with an impulse width of approx. 1 ns. The emitted beam is, for example, split up by way of semi-permeable mirrors 2 and conducted to n colouring material lasers 3. Corresponding to the applied laser colouring material, the colouring material lasers 3 emit the required excitation beam, where the impulse laser 1 can also be used directly as an excitation source. By way of an optical delay 4, such as glass fibres, the excitation beam is delayed in such a way that only one fluorescence colouring material contained in the sample is always excitated near its absorption maximum. By means of the delay, it must be ensured that the individual fluorescence colouring material is thoroughly decayed up to the next excitation process. This presupposes knowledge of the life duration of the fluorescence colouring materials to be verified.

The excitation beam is conducted to the fluorescence sample 7 by way of light wave conductors 5, 6. The fluorescence signals are conducted to a optical detector 9, for example by way of the fibre-optical connections 5, 6. In addition, the fluorescence signals can be spectrally filtered by way of filter 8. In the time range, the detector 9 must be able to approximately follow the fluorescence signals (e.g., photo diodes, SEV). The electric signal of the detector 9 is subsequently an image of the excitated fluorescence in the time range (FIG. 2). A gated integrator 10, with a gate time significantly shorter that the life duration of the fluorescence (e.g., 1 ns), can scan the signal at a defined point in time.

In accordance with the illustration in FIG. 2, and under the prerequisite that the fluorescence colouring materials A and B to be verified have different life durations, the fluorescence signal β, measured in the gate position b, can be thoroughly separated from the fluorescence signal α of the colouring material A, measured in the gate position a. This method allows the separation of fluorescence colouring materials even in such circumstances where they cannot be separated by the selection of the excitation wave length or/and the emission wave length.

The electric signal coming from the gated integrator 10 can, after this, be digitalised in an A/D-transformer 11 and further processed in a PC 12.

### Reference Parts List

1 Impulse laser

2 Beam splitter mirror

3 Colouring material laser

4 Delay module

5 Light wave conductor

6 Light wave conductor

7 Sample

8 Filter

9 Photo detector

10 Gated integrator

11 Analog digital transformer

12 Computer (PC)

a Gate position

b Gate position

α/A Fluorescence signal/colouring material

β/B Fluorescence signal/colouring material

1. Method for the multi-fluorescence detection of fluorophores by means of a simultaneous measurement of the decay time of the fluorescences, where the excitation wave lengths for the individual fluorophores, delayed through an optical delay (4) in the range of sub-nanoseconds to some milliseconds, are conducted to the objects of examination (7) so that the fluorescences can be excitated and detected one after the other and where, for the differentiation between at least two fluorophores in addition to their spectral characteristics, the decay behaviour of the fluorescence processes is examined by the displacement of electronic gates in the nanosecond range along a timing axis.

2. Method for the multi-fluorescence detection of fluorophores by means of a simultaneous measurement of the decay time of the fluorescences, where the excitation wave lengths for the individual fluorophores, delayed through an optical delay (4) in the range of sub-nanoseconds to some milliseconds, are conducted to the objects of examination (7) so that the fluorescences can be excitated and detected one after the other.

3. Method for the multi-fluorescence detection of fluorophores by means of a simultaneous measurement of the decay time of the fluorescences where, for the differentiation between at least two fluorophores in addition to their spectral characteristics, the decay behaviour of the fluorescence processes is examined by the displacement of electronic gates in the nanosecond range along a timing axis.

4. Method according to claim 1 and 3,
wherein the delay (4) is formed by light wave conductors.

5. Method according to claim 2 and 3
wherein the electronic time gate is positioned in the maximum of the timing pattern of the life duration of the fluorescence signal, in order to selectively detect fast decaying fluorescence processes.

6. Method according to claim 2 and 3,
wherein the electronic time gate is positioned in the fade-out of the timing pattern of the life duration of the fluorescence signal, in order to selectively detect slow decaying fluorescence processes.

7. Method according to the claims 1 to 3,
wherein several different fluorescence colouring materials are detected in the liquid chromatography.

8. Method according to the claims 1 to 3,
wherein fluorescence colouring materials are detected in multi-well plates.

9. Method according to the claims 1 to 3,
wherein a multiple fluorescence detection is carried out on living/dead tissue.

10. Method according to the claims 1 to 3,
wherein a multiple fluorescence detection is carried out on planar, particular, fibrillar carriers such as DNA-/protein-chip.

11. Method according to the claims 1 to 3,
wherein the method is image-rendering and the detector is a camera.

12. Method according to the claims 1 to 3,
wherein a multiple fluorescence detection and an end-point determination is carried out during the PCR, particularly quantitative and multiplex PCR.

13. Method according to the claims 1 to 3,
wherein several fluorescence colouring materials are detected in electrophoresis gels, electrophoresis capillaries and electrophoresis blots.
